(19) United States
(12) Patent Application Publication
(10) Pub. No.: US 2021/0161274 A1
(43) Pub. Date: Jun. 3, 2021

(54) COSMETIC CONTAINER PROVIDED WITH PUMP INCLUDING PART MADE OF POLYKETONE MATERIAL

(71) Applicant: Do Hoon LEE, Incheon (KR)

(72) Inventor: Do Hoon LEE, Incheon (KR)

(21) Appl. No.: 16/954,074

(22) PCT Filed: Oct. 29, 2018
(86) PCT No.: PCT/KR2018/012882

§ 371 Date: Jun. 15, 2020

(30) Foreign Application Priority Data
Dec. 21, 2017 (KR) 10-2017-0177139

(51) Int. Cl. A45D 34/00; B05B 11/00

(52) U.S. Cl. CPC A45D 34/00; A45D 2200/055; B05B 11/3052; B05B 11/3001

(57) ABSTRACT

The present invention relates to a cosmetic container provided with a pump including a part made of a polyketone material, wherein the pump functions to pump a cosmetic to the outside and has some part made of the eco-friendly material polyketone, whereby the problems of odor generation and harmfulness of formaldehyde, which is a raw material for the conventional substance polyacetal (polyoxymethylene (POM)), can be eliminated to give the user neither an unpleasant feeling nor irritation, thus allowing the user to use the cosmetic safely.

### TECHNICAL FIELD

The present invention relates to a cosmetic container provided with a pump including a part made of a polyketone material and, more particularly, to a cosmetic container provided with a pump including a part made of a polyketone material, wherein the pump functions to pump a cosmetic to the outside and has some part made of the eco-friendly material polyketone, whereby the problems of odor generation and harmfulness of formaldehyde, which is a raw material for the conventional substance polyacetal (polyoxymethylene (POM)), can be eliminated to give the user neither an unpleasant feeling nor irritation, thus allowing the user to use the cosmetic safely.

### BACKGROUND ART

Cosmetics refer to goods which are used for a human body in order to add charming of the human body and change the appearance of the human body to be brighter, or to maintain or enhance skin or hair in a healthy state by making the human body clean and beautiful.

When cosmetics are classified according to the purpose of use, cosmetics are classified into facial cosmetics used to remove sebum, waste and contaminants on the skin surface, basic cosmetics used to properly supply moisture and oil to the skin, color cosmetics used to express beautiful colors, hair cosmetics used to protect hair and supply nutrients while removing foreign substances from the hair or scalp, and perfumes used to give fragrance to others by dissolving fragrances in alcohol.

As the cosmetics described above have been developed, there is a need to develop various cosmetic containers capable of containing cosmetics.

In general, according to the related art, to store and use liquid or gel type cosmetics such as lotions, creams, gels, shampoos, rinses, PITC among cosmetics, becauseasimple container has an opening/closing function, the cosmetics are taken out of the container with a paddle or a finger to be applied to the skin.

However, the conventional cosmetic container does not always regulate the amount of cosmetics discharged, so that the cosmetics are wasted.

To solve the above problems, as shown in FIG. 1, a pump for cosmetics is disclosed in Korean Registered Patent No. 10-1376050, which includes a housing 1 constituting an outer appearance of the pump, a fixed bushing 2 fixedly coupled to an upper portion of the housing 1, a piston support 3 vertically moved in the housing 1, a piston 4 fitted to an outside of the piston support 3 and vertically moved together with the piston support 3, a stem 5 coupled to an upper portion of the piston support 3 and pressed by a button 7, and a spring 6 elastically supporting the stem 5, where the fixed bushing 2, the piston support 3 and the stem 5 are generally made of polyacetal (polyoxymethylene (POM)), which is recyclable and cost-competitive.

However, among the pump parts of the related art, since the fixed bushing 2, the piston support 3 and the stem 5 are formed of polyacetal (polyoxymethylene (POM)), they are worn by friction between parts during long-term use. Accordingly, the sealing force between the pump parts is reduced, and the compression force is reduced, so that the pump is difficult to discharge quantitatively.

In addition, because the polyacetal (polyoxymethylene (POM)) used as the pump material of the related art contains formaldehyde in the raw material, which is harmful, stinks by the formaldehyde, and comes into contact with the cosmetic material which is a chemical product, when the cosmetic container is not used for a long time, the odor of formaldehyde is discharged together with the cosmetic material, causing discomfort or irritation to the user.

Therefore, it is urgent to find a synthetic resin material that can replace polyacetal (polyoxymethylene (POM)) which has been used as a material for some parts of cosmetic pumps, has excellent wear resistance, is not harmful, and does not stink.

### DISCLOSURE

### Technical Problem

To solve the problems described above, an object of the present invention is to providea cosmetic container provided with a pump including a part made of a polyketone material, wherein the pump functions to pump a cosmetic to the outside and has some part made of the eco-friendly material polyketone, whereby the problems of odor generation and harmfulness of formaldehyde, which is a raw material for the conventional substance polyacetal (polyoxymethylene (POM)), can be eliminated to give the user neither an unpleasant feeling nor irritation, thus allowing the user to use the cosmetic safely.

In addition, another object of the present invention is to providea cosmetic container provided with a pump including a part made of a polyketone material, where, among the parts of the pump, a stem and a fixed bushing and a piston support are formed of poi ketone having better wear resistance than existing materials, so that even if the pump is used for a long time, it is worn by friction between the pump parts. Accordingly the cosmetic container provided with a pump including a part made of polyketone can be reused by continuously dispensing fixed amount of cosmetics by maintaining a stable sealing force and compressive force between the pump parts.

### Technical Solution

According to one aspect of the present invention, there is provided a cosmetic container provided with a pump for pumping a cosmetic material to an outside,

wherein the pump includes a housing formed at one side thereof with a cosmetic inlet, a suction valve for opening and closing the cosmetic inlet of the housing, a fixed bushing fixedly coupled to the housing, a piston support formed inside the housing, a piston fitted to an outside of the piston support and tightly closed to an inside surface of the housing, a stem coupled to the piston support, andan elastic member for elastically supporting the stem, and

wherein the stern is formed of a polyketone material.

According to another aspect of the present invention, there is provided a cosmetic container provided with a pump for pumping a cosmetic material to an outside,

wherein the pump includes a housing formed at one side thereof with a cosmetic inlet, a suction valve for opening and closing the cosmetic inlet of the housing, fixed bushing fixedly coupled to the housing, a piston support formed inside the housing, a piston fitted to an outside of the piston support and tightly closed to an inside surface of the housing, a stem coupled to the piston support, and an elastic member for elastically supporting the stem, and

wherein the piston support of the pump is formed of a polyketone material.

The pump is installed on one side of a container body, and is pressed by a push button.

The cosmetic container may further include a pump cap formed on an outside of the pump.

The fixed bushing may be formed of the polyketone material.

The housing of the pump may be formed of a polypropylene material.

The suction valve and the piston may be formed of a low-density polyethylene material.

The push button may be formed of a polypropylene material.

The stem of the pump may be moved up and down in close contact with an inner peripheral surface of the fixed bushing.

### Advantageous Effects

According to the cosmetic container provided with a pump including a part made of a polyketone material of the present invention, the pump functions to pump a cosmetic to the outside and has some part made of the eco-friendly material polyketone, so that the problems of odor generation and harmfulness of formaldehyde, which is a raw material for the conventional substance polyacetal (polyoxymethylene (POM)), can be eliminated to give the user neither an unpleasant feeling nor irritation, thereby allowing the user to use the cosmetic safely.

In addition, according to the cosmetic container provided with a pump including a part made of a polyketone material of the present invention, the stem, the fixed bushing and the piston support among some parts of the pump are formed of polyketone having better wear resistance than existing materials, so that even if the pump is used for a long time, it is worn by friction between the pump parts. Accordingly the cosmetic container provided with a pump including a part made of polyketone can be reused by continuously dispensing a fixed amount of cosmetics by maintaining a stable sealing force and compressive force between the pump parts.

### DESCRIPTION OF DRAWINGS

FIG. 1 is a perspective view showing a compact container according to the related art.

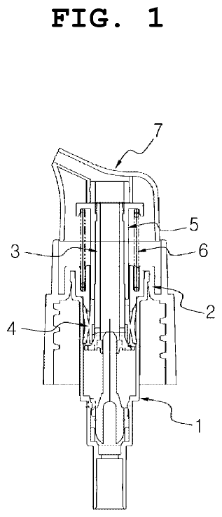

FIG. 2 is a perspective view of a cosmetic container according to the present invention.

FIG. 3 is an exploded perspective view of a cosmetic container according to the present invention.

FIG. 4 is a cross-sectional view of a cosmetic container according to the present invention.

FIG. 5 is a partial cross-sectional view of a cosmetic container according to the present invention.

FIG. 6 is a cross-sectional view showing a state in which a cosmetic material is discharged to an outside by pressing the push button of cosmetic container according to the present invention.

FIG. 7 is a cross-sectional view showing a state in which a cosmetic material is sucked into a housing when the pressure on the push button of a cosmetic container according to the present invention is removed.

### BEST MODE

### Mode for Invention

Technical objects to be achieved by the present invention and embodiments of the present invention will be apparent through preferable embodiments to be described below. Hereinafter, a compact cosmetics container having an opening/closing button formed in a lid thereof according to the present invention will be described with reference to accompanying drawings.

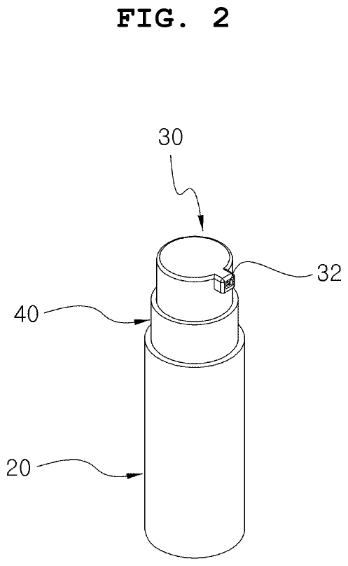

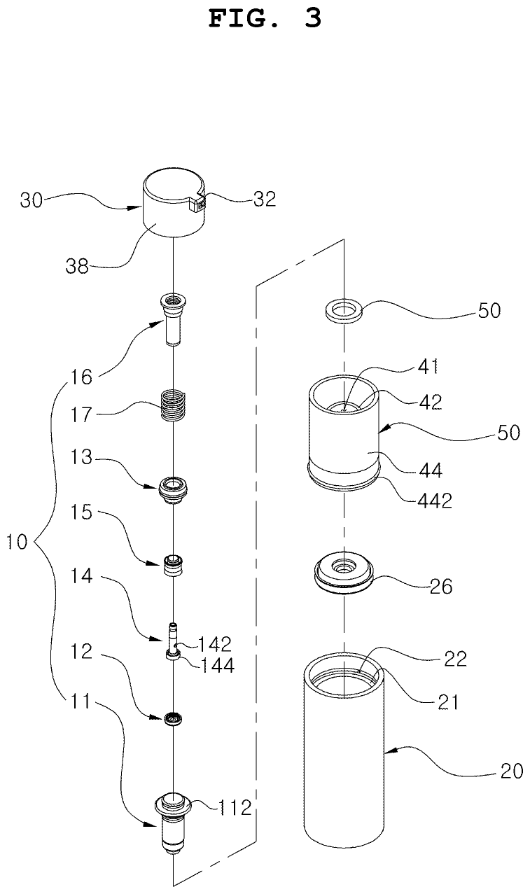

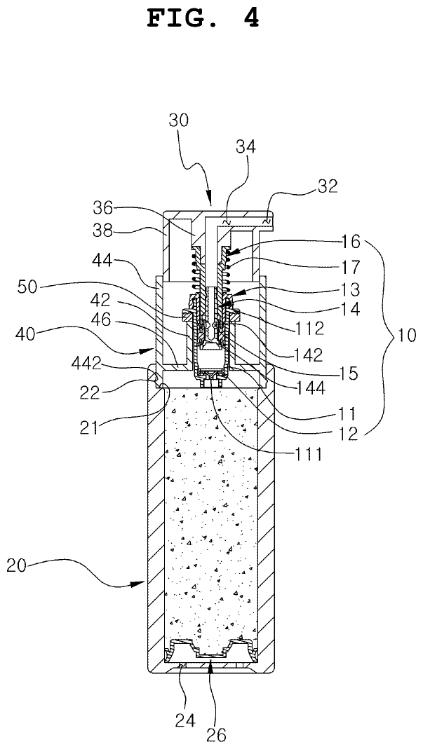

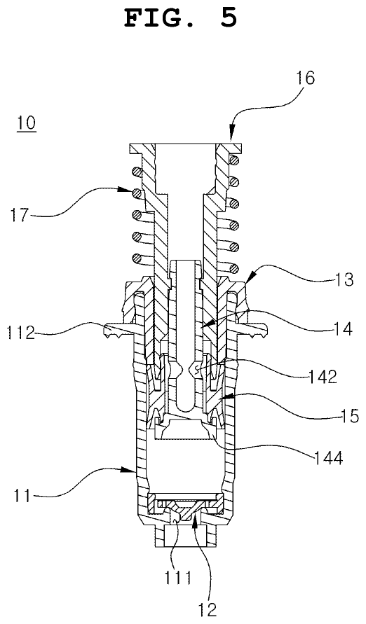

FIG. 2 is a perspective view of a cosmetic container according to the present invention. FIG. 3 is an exploded perspective view of a cosmetic container according to the present invention. FIG. 4 is cross-sectional view of a cosmetic container according to the present invention. FIG. 5 is a partial cross-sectional view of a cosmetic container according to the present invention.

A cosmetic container provided with a pump having a part made of a polyketone material, in which the pump 10 pumps a cosmetic material to an outside, includes a housing 11 having a cosmetic inlet 111 formed on one side, a suction valve 12 for opening and closing the cosmetic inlet 111 of the housing 11, a fixed bushing 13 fixedly coupled to the housing 11, a piston support 14 formed inside the housing 11, a piston 15 fitted to an outside of the piston support 14 and tightly closed to an inside surface of the housing 11, a stem 16 coupled to the piston support 14, and an elastic member 17 for elastically supporting the stem 16.

As shown in FIG. 4, the pump 10 is installed on one side of a container body 20, and is pressurized by a push button 30.

The container body 20 contains a liquid or gel type cosmetic material therein, and has an opened upper portion.

A coupling groove 22 is formed on an upper inner periphery of the container body 20, and a separation preventing sill 21 is formed on a lower portion of the coupling groove 22.

A ventilation groove 24 is formed on a bottom of the container body 20 to allow external air to flow into the container body 20.

A pushing plate 26 is formed inside the container body 20, and the pushing plate 26 is in close contact with the inner periphery of the container body 20, such that the pushing plate moves upward as much as the amount of cosmetics is discharged and exhausted.

The push button 30 is installed on an upper portion of the pump 10 to operate while pressing the pump 10.

An outlet 32 for discharging a cosmetic material to an outside is formed on one side of the push button 30, and an outlet passage 34 for moving the cosmetic material to the outlet 32, which is formed inside the outlet 32, is connected to the pump 10.

As shown in FIG. 4, a lower inner wall 36 which extends downward and a lower outer wall 38 which extends downward while being spaced apart from an outside of the lower inner wall 36 by a predetermined interval are formed in the push button 30.

The lower inner wall 36 of the push button 30 is coupled to the stem 16 of the pump 10 to move the pump 10 downward.

Preferably, the push button 30 is formed of a polypropylene (pp) material.

A pump cap 40 is further formed on an upper portion of the container body 10 to surround the outside of the pump 10.

The lower portion of the pump cap 40 is fixedly coupled to the upper portion of the container body 10, and the push button 30 moves up and down toward the upper side of the pump cap 40.

As shown in FIG. 4, an upper inner wall 42 which extend upwardly and an upper outer wall 44 which extends outwardly of the upper inner wall 42 while being spaced apart by a predetermined interval are formed on the pump cap 40, and a connection plate 44 for connecting the upper inner and outer walls 42 and 44 extends horizontally.

A through hole 41 is formed inside upper inner wall 42 of the pump cap 40 to install the pump 10.

A lower end of the upper outer wall 44 is placed on the separation preventing sill 21 of the container body 10 to be prevented from falling into an inside of the container body 10, and a coupling protrusion 442 is formed on the lower outer periphery of the upper outer wall 41 to be coupled to the coupling groove 22 of the container body 10.

The pump 10 is installed adjacent to the container body 20 to pump the liquid or gel-type cosmetic material contained in the container body 10 to discharge the liquid or gel-type cosmetic material to the outside.

As shown in FIG. 5, the pump 10 includes a housing 11 formed on one side with a cosmetic inlet 111, a suction valve for opening and closing the cosmetic inlet 111 of the housing 11, a fixed bushing 13 fixedly coupled to the housing 11, a piston support 14 formed inside the housing 11 to move inward or outward, a piston 15 fitted to an outside of the piston support 14 and tightly closed to an inside surface of the housing 11, a stem 16 coupled to the piston support 14, and an elastic member 17 for elastically supporting the stem 16.

The housing 11 is coupled through the through hole 41 of the pump cap 40, and the cosmetic inlet 111 of the housing 11 is located toward the inside of the container body 10.

Preferably, the housing 11 is formed of a polypropylene (pp) material.

A receiving sill 112 is formed on the outer periphery of the housing 11 to be placed on an upper end of the upper inner wall 42 of the pump cap 40, and as shown in FIG. 4, a sealing ring 50 may be further formed between the receiving sill 112 and the upper inner wall 42 to enhance the sealing force.

A suction valve 12 is formed in the cosmetic inlet 111 of the housing 11, and serves to introduce or block the cosmetic material contained in the container body 10 into the housing 11.

The fixed bushing 13 is coupled to the upper portion of the housing 11 as shown in FIG. 5 to seal the inside of the housing 11, and at the same time, surround the outer periphery of the stem 16, such that the stem 16 is guided to move vertically without shaking.

The piston support 14 moves up and down inside the housing 11, and an inlet passage 142 through which the cosmetic material stored temporarily in the housing passes is formed on the outer periphery of the piston support 14. A locking portion. 144 that prevents the piston 15 from falling downward is formed on a lower portion of the piston support 14.

The piston 15 is fitted to the outside of the piston support 14 and moves up and down together with the piston support 14. The suction valve 12 and the piston 15 of the pump 10 are preferably formed of a low-density polyethylene (LDPE) material having elasticity.

The stem 16 connects the push button 30 and the piston support 14 to transmit the vertical movement of the push button 30 to the piston support 14.

As shown in FIG. 4, the upper portion of the stem 16 is coupled to the lower inner wall 36 of the push button 30, and the lower portion is coupled to the piston support 14.

The stem 16 moves vertically while being in close contact with the inner peripheral surface of the fixed bushing 13, thereby maintaining the sealing force in the housing 11.

According to the related art, the stem 16 and the piston support 14 have been formed of a polyacetal (Polyoxymethylen (POM)) material. However, according to the present invention, the stem 16 and the piston support 14 are formed of a polyketone material to eliminate the problems described below

The polyketone is a new polymer material composed of carbon monoxide, ethylene and propylene and is a material excellent in eco-friendliness, wear resistance, chemical resistance (stable properties in acids, oils, bases, and moisture), impact resistance, scratch resistance (scratch reduction), etc.

That is, the polyacetal (Polyoxymethylen (POM), which 1s used as a material for the stem 16 and the piston support 14 according to the related art, contains formaldehyde in the material, and thus has a problem, of harmfulness. When odor is generated by the formaldehyde and is in contact with a cosmetic product which is a chemical product and the cosmetic container is used after not being used for a long time, the odor of formaldehyde is discharged together with the cosmetic material to offend or irritate the user. In addition, when used for a long time, the cosmetic container is worn due to friction between parts, and as a result, the sealing force between pump parts is reduced, so that the compressive force decreases, so it is difficult to quantitatively discharge the cosmetic material and it is impossible to reuse the cosmetic container.

Thus, according to the cosmetic container of the present invention, one of the stem 16 and the piston support 14 of the pump 10, or both the stem 16 and the piston support 14 are made of eco-friendly material, polyketone material to remove the odor and harmfulness generated from formaldehyde, so that the user may safely use the cosmetic container.

However, when the pump 10 is operated, the stem 16 causes friction with the inner peripheral surface of the fixed bushing 13 while moving up and down, and the fixed bushing 13 is not only easily worn by the stem 16 formed of polyketone, but also more formaldehyde is discharged from, the fixed bushing 13 formed of a conventional polyacetal (polyoxymethylen (POM)), so that the harmfulness of cosmetics applied to the skin.is enhanced.

Accordingly, in the present invention, the fixed bushing 13 is formed of a polyketone material excellent in eco-friendliness, wear resistance, chemical resistance, and scratch resistance, etc., so that it is possible to prevent wear caused by friction between parts of the pump 10 even when being used for a long time and prevent formaldehyde from being discharged, thereby solving the harmfulness problem. In addition, the pump 10 is capable of continuously discharging a fixed amount of cosmetics.

As described above, the cosmetic container according to the present invention has some parts of the pump 10 that are formed of polyketone that is more excellent in wear resistance than polyacetal (polyoxymethylen (POM)) and is an eco-friendly material without odor and harmfulness, so that the stability and functionality of the pump 10 are improved.

The elastic member 17 elastically supports the stem 16 and is in close contact with a protrusion 162 which has a lower end placed on an upper end of the fixed bushing 13 and an upper end formed on an upper periphery of the stem 16.

Hereinafter, an assembly method and use state of a cosmetic container provided with a pump including a part made of a polyketone material according to an embodiment of the present invention will be described in detail.

First, in order to assemble a cosmetic container equipped with a pump having a component of polyketone material according to an embodiment of the present invention, as shown in FIGS. 3 and 4, the sealing plate 26 is inserted inside the container body 20. Then, a liquid or gel cosmetic is filled in the container body 20.

Next, the pump cap 40 is coupled to the upper portion of the container body 20. In this case, coupling protrusion 442 of the pump cap 10 and the coupling groove 22 of the container body 10 are coupled to each other.

Next, as shown in FIG. 5, the pump 10 including the housing 11, the suction valve 12, the fixed bushing 13, the piston support 14, the piston 15, and the stem 16 is installed into the through hole 41 of the pump cap 40. When the sealing ring 50 is further formed between the pump cap 40 and the housing 11, after the sealing ring 50 is fitted to the outside of the housing 11 of the pump 10, the pump 10 is installed into the through hole 41 of the pump cap 40.

Finally, by assembling the push button 30 on the upper portion of the stem 16 of the pump 10, the assembly of the cosmetic container provided with a pump including a part made of a polyketone material according to an embodiment of the present invention is completed.

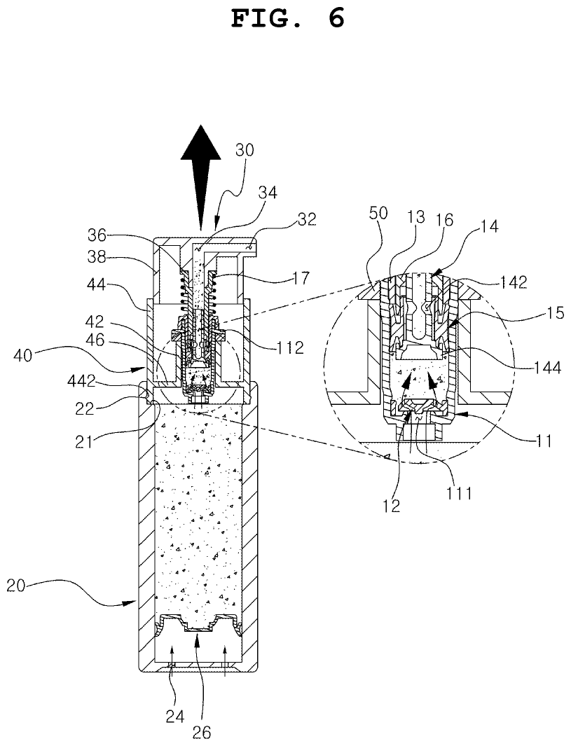

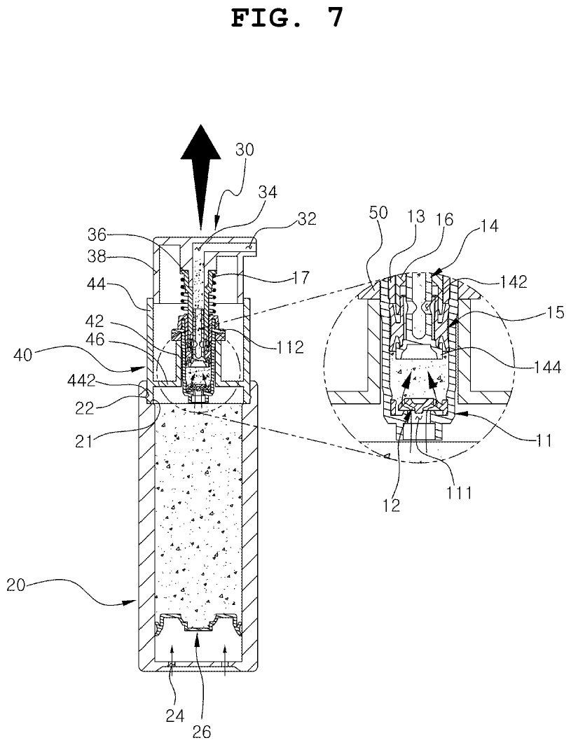

FIG. 6 is a cross-sectional view showing a state in which a cosmetic material is discharged to an outside by pressing the push button of a cosmetic container according to the present invention. FIG. 7 is a cross-sectional view showing a state in which a cosmetic material is sucked into a housing when the pressure on the push button of a cosmetic container according to the present invention is removed.

In order to use the cosmetic container provided with a pump including a part made of a polyketone material assembled in the above-described manner, as shown in FIG. 6, first the push button 30 is pushed to move the stem 16 of the pump 10 coupled to the push button 30 downward.

While the stem 16 of the pump 10 moves downward, the piston support 14 coupled to the lower portion of the stem 16 moves downward together.

In this case, since the piston 15 of the pump 10 is in close contact with the inner surface of the housing 11, as shown in the partially enlarged view of FIG. 6, only the piston support 14 moves downward, so that a gap is created between the piston support 14 and the piston 15, thereby creating a passage for discharging a cosmetic material.

Thereafter, when the push button 30 is continuously pressed, the lower end of the stem 16, which moves downward by the push button 30, presses the piston 15 so that the piston 15 moves downward with the piston support 14, thereby reducing the inner volume of the housing 31. Thus, the suction valve 12 closes the cosmetic inlet 111 by the discharge pressure in the housing 11, and at the same time, the cosmetic material contained in the housing 11, which comes out between the piston support 14 and the piston 15, passes through the inlet passage 142 of the piston support 14 and then, is discharged through the discharge passage 34 of the push button 30 to the outlet 32.

Thereafter, as shown in FIG. 7, when the pressure on the push button 30 is removed, the stem 16 is moved upward by the elasticity of the elastic member 17 that elastically supports the stem 16 of the pump 10, and the piston support 14 coupled to the lower portion of the stem 16 also moves upward. In this case, the locking portion 144 of the piston support 14 pulls up the piston 15, so that the piston support 14 and the piston 15 move together while the gap between the piston support 14 and the piston 15 is blocked, so the inner volume of the housing 11 increases, thereby generating a vacuum pressure.

Thereafter, while the suction valve 12 was lifted by the vacuum pressure generated inside the housing 11, the cosmetic inlet 111 formed on the bottom surface of the housing 11 is opened, so that the cosmetic material contained in the container body 20 flows into the housing 11 through the cosmetic inlet 111 as shown in the partially enlarged view of FIG. 7 and at the same time, the pushing plate 26 formed inside the container body 20 move upward as much as the cosmetic material discharged.

As described above, the cosmetic container provided with a pump including a part made of a polyketone materialdescribed in this disclosure is an illustrative purpose only, and the present invention is not limited thereto. Thus, it should be understood that numerous other modifications and embodiments can be devised by those skilled in the art within the spirit and scope of the present invention and they will fall within the scope of the present invention.

### DESCRIPTION OF REFERENCE NUMERAL

10: Pump
11: Housing
12: Suction valve
13: Fixed bushing
14: Piston support
15: Piston
16: Stem
17: Elastic member
20: Container body
30: Pushing button
40: Pump cap
50: Sealing ring

1. A cosmetic container provided with a pump for pumping a cosmetic material to an outside, wherein the pump comprises:
a housing formed at one side thereof with a cosmetic inlet;
a suction valve for opening and closing the cosmetic inlet of the housing;
a fixed bushing fixedly coupled to the housing;
a piston support formed inside the housing;
a piston fitted to an outside of the piston support and tightly closed to an inside surface of the housing;
a stem coupled to the piston support; and
an elastic member for elastically supporting the stem, and
wherein the stem is formed of a polyketone material.

2. A cosmetic container provided with a pump for pumping a cosmetic material to an outside, wherein the pump comprises:
a housing formed at one side thereof with a cosmetic inlet;
a suction valve for opening and closing the cosmetic inlet of the housing;
a fixed bushing fixedly coupled to the housing;
a piston support formed inside the housing;
a piston fitted to an outside of the piston support and tightly closed to an inside surface of the housing;
a stem coupled to the piston support; and
an elastic member for elastically supporting the stem, and
wherein the piston support of the pump is formed of a polyketone material.

3. The cosmetic container of claim 1, wherein the pump installed on one side of a container body, and is pressed by a push button.

4. The cosmetic container of claim 1, further comprising:
a pump cap formed on an outside of the pump.

5. The cosmetic container of claim 1, wherein the fixed bushing is formed of the polyketone material.

6. The cosmetic container of claim 5, wherein the housing of the pump is formed of a polypropylene material.

7. The cosmetic container of claim 5, wherein the suction valve and the piston are formed of a low-density polyethylene material.

8. The cosmetic container of claim 5, wherein the push button is formed of a polypropylene material.

9. The cosmetic container of claim 1, wherein the stem of the pump is moved up and down in close contact with an inner peripheral surface of the fixed bushing.

10. The cosmetic container of claim 2, wherein the pump is installed on one side of a container body, and is pressed by a push button.

11. The cosmetic container of claim 2, further comprising:
a pump cap formed on an outside of the pump.

12. The cosmetic container of claim 2, wherein the fixed bushing is formed of the polyketone material.

13. The cosmetic container of claim 12, wherein the housing of the pump is formed of a polypropylene material.

14. The cosmetic container of claim 12, wherein the suction valve and the .Aston are formed of a low-density polyethylene material.

15. The cosmetic container of claim 12, wherein the push button is formed of a polypropylene material.

16. The cosmetic container of claim 2, wherein the stem of the pump is moved up and down in close contact with an inner peripheral surface of the fixed bushing.
